(19) United States
(12) Patent Application Publication
(10) Pub. No.: US 2020/0102992 A1
(43) Pub. Date: Apr. 2, 2020

(54) VEHICLE BRAKING SYSTEM

(71) Applicant: HONDA MOTOR CO., LTD., Tokyo (JP)

(72) Inventors: Shingo MIYAKE, Wako-shi (JP); Hei GO, Yokohama-shi (JP)

(21) Appl. No.: 16/585,432

(22) Filed: Sep. 27, 2019

(30) Foreign Application Priority Data
Sep. 28, 2018 (JP) 2018-184855

(51) Int. Cl. F16D 65/00; F16D 65/847

(52) U.S. Cl. CPC F16D 65/0081; B60T 1/065; F16D 65/847

(57) ABSTRACT

A vehicle braking system includes a splash guard: adjacently arranged on a vehicle body while facing a sliding part of a disc-shaped rotor which rotates about an axle; made of a plate-shaped member which includes multiple cooling holes each being a through-hole penetrating through a plate surface; and formed in a shape linearly symmetrical with respect to a symmetrical axis that is a straight line located on the plate surface and intersecting the axle.

### CROSS-REFERENCE TO RELATED APPLICATION

This application is based upon and claims priority from the Japanese Patent Application No. 2018-184855, filed on Sep. 28, 2018, the entire contents of which are incorporated herein by reference.

### BACKGROUND OF THE INVENTION

### 1. Field of the Invention

The present invention relates to a vehicle braking system for braking a vehicle.

### 2. Description of the Related Art

A disc brake is widely used as a vehicle braking system. The disc brake squeezes pads (frictional members) against two plate surfaces of a disc-shaped rotor which rotates integrally with a wheel, and thereby slows or stops the rotation of the wheel. The disc brake like this, however, may fail to exert sufficient braking force when the disc brake performs braking with foreign objects such as dust, small stones and muddy water caught between the rotor and the pads.

The rotor is therefore covered with a splash guard in order to prevent foreign objects from getting between the rotor and the pads.

For example, Japanese Patent Application Publication No. 2002-276698 (hereinafter referred to as Patent Document 1) discloses a vehicle braking system provided with a splash guard which includes fixing holes and a cable hole.

Meanwhile, Japanese Utility Model Registration Application Publication No. Sho 62-204044 (hereinafter referred to as Patent Document 2) discloses a vehicle braking system provided with a splash guard which is embossed for reinforcement purpose.

### SUMMARY OF THE INVENTION

The covering of the rotor with the splash guard like this makes it possible to prevent foreign objects from getting between the rotor and the pads, but increases manufacturing costs due to an increase in the number of parts for the braking system. In many cases, the structure of a braking system in the front section of a vehicle is different from that of a braking system in the rear section of the vehicle. It is therefore difficult to use common splash guards in both the front and rear sections of the vehicle. On the other hand, the structure of a braking system in the left section of the vehicle is the same as that of a braking system in the right section of the vehicle. Common splash guards can be therefore used in both the left and right sections of the vehicle.

The splash guards according to Patent Documents 1 and 2, however, do not pay consideration to commonality of the splash guards in both the left and right sections of the vehicle, and therefore have a problem that the left and right splash guards have different shapes, which makes it difficult to reduce costs.

The present invention has been made to solve the above problem, and has an object to provide a vehicle braking system which makes it possible to reduce manufacturing costs by using common splash guards in both the left and right sections of the vehicle.

For the purpose of achieving the above object, a vehicle braking system according to the present invention includes a splash guard: adjacently arranged on a vehicle body while facing a sliding part of a disc-shaped rotor which rotates about an axle; made of a plate-shaped member which includes multiple cooling holes each being a through-hole penetrating through a plate surface; and formed in a shape linearly symmetrical with respect to a symmetrical axis that is a straight line located on the plate surface and intersecting the axle.

The present invention can provide the vehicle braking system which makes it possible to reduce manufacturing costs by using the common splash guards in both the left and right sections of the vehicle.

### BRIEF DESCRIPTION OF THE DRAWINGS

FIG. 1 is a front view showing how a splash guard is attached to a knuckle in a vehicle braking system according to an embodiment.

FIG. 2 is a rear view showing how the splash guard is attached to the knuckle in the vehicle braking system according to the embodiment.

FIG. 3 is a rear view showing how the splash guard and a rotor are attached to the knuckle in the vehicle braking system according to the embodiment.

FIG. 4 is a perspective view showing the splash guard in the vehicle braking system according to the embodiment.

FIG. 5 is a cross-sectional view taken along the V-V line in FIG. 4.

FIG. 6 is a cross-sectional view taken along the VI-VI line in FIG. 4.

FIG. 7 is a magnified perspective view showing a main section indicated with an arrow VII in FIG. 3.

FIG. 8 is a magnified perspective view showing a main section indicated with an arrow VIII in FIG. 3.

### DETAILED DESCRIPTION OF THE EMBODIMENTS

An embodiment of the present invention will be hereinafter described in detail with reference to the accompanying drawings. Incidentally, in the following descriptions, the same components will be denoted by the same reference signs, and duplicated descriptions for the components will be omitted.

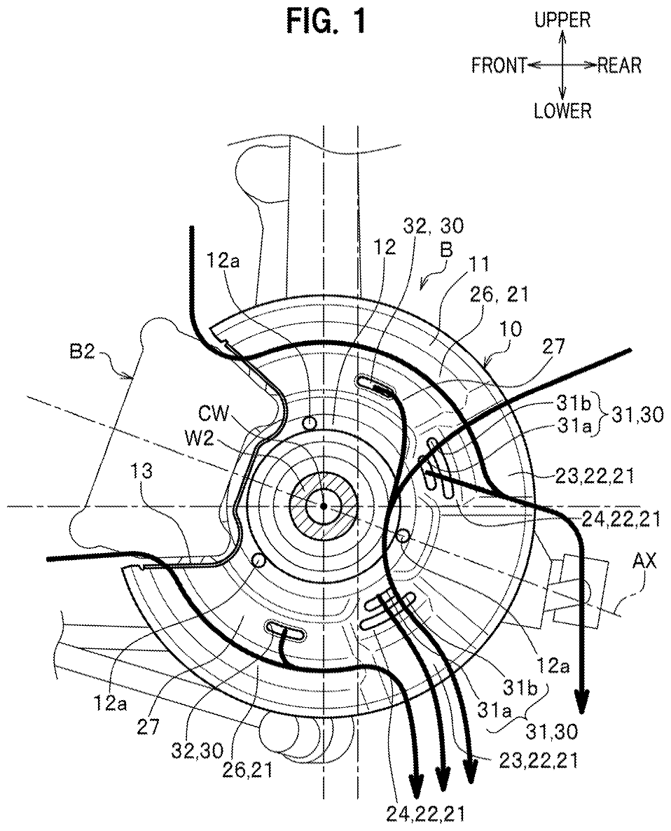

As illustrated in FIGS. 1 to 3, a disc brake B (a vehicle braking system) according to the embodiment has a configuration for slowing or stopping the rotation of a rear wheel (not illustrated) which is not a drive wheel, and is installed on a rear wheel knuckle W1 (a vehicle body).

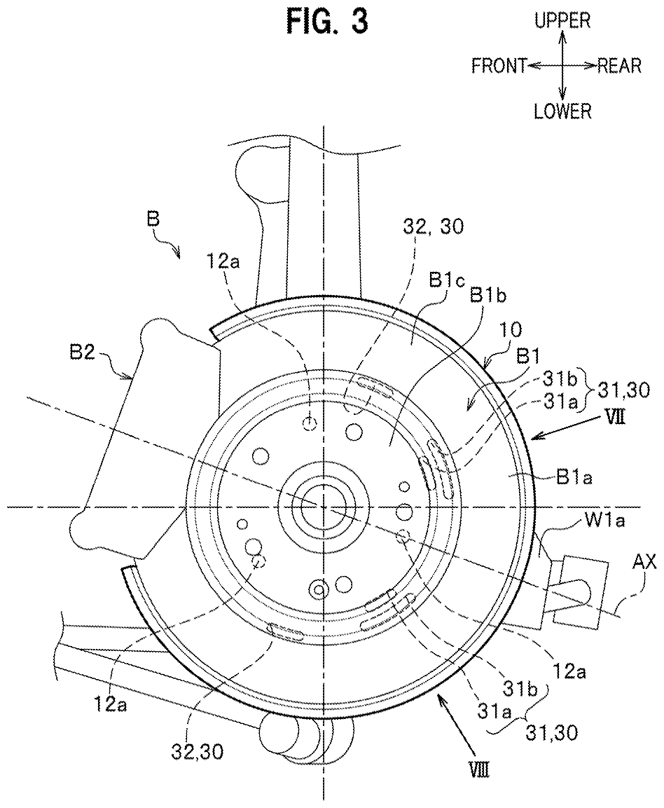

In addition, the disc brake B according to the embodiment includes a rotor B1, a caliper B2, and a splash guard 10 (see FIG. 3).

When the driver steps on the brake pedal, the caliper B2 works in the disc brake B. The caliper B2 squeezes brake pads (not illustrated), arranged to face each other in the caliper B2, against the rotor B1 rotating integrally with the wheel to slow or stop the vehicle.

While the vehicle is running, foreign objects such as dust, small stones and muddy water are sent flying around the wheel (not illustrated) on which the above-configured disc brake B is mounted. Flying foreign objects may adhere to the rotor B1, and may get into clearances between the caliper B2 and the rotor B1.

When the brake pads are squeezed against the rotor B1 with foreign objects caught between the rotor B1 and the brake pads, there is a likelihood that desired braking force cannot be obtained, and the rotor B1 and the brake pads may be damaged.

In addition, when muddy water is splashed over a hub bearing W2, various particles in the muddy water may wear the hub bearing W2 more easily than otherwise.

With this taken into consideration, the splash guard 10 is set in the disc brake B (the vehicle braking system) according to the embodiment in order to inhibit foreign objects from getting into the disc brake B.

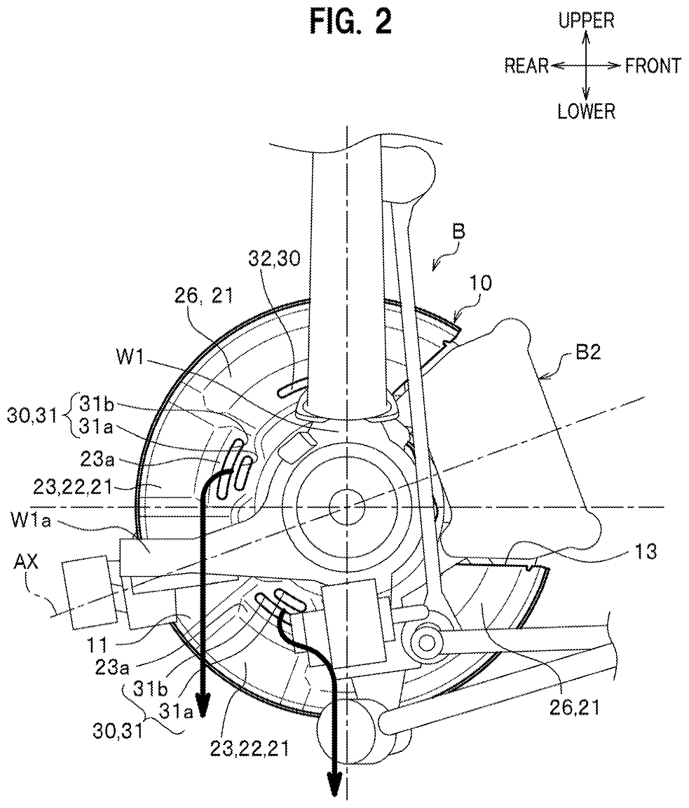

It should be noted that in FIGS. 1 and 2, arrows show how foreign objects are discharged from the disc brake B after getting into the disc brake B.

Furthermore, a symmetrical axis AX is set in the embodiment.

The symmetrical axis AX is represented by a straight line which is located on a plate surface 10a of the splash guard 10 and arranged along a sliding surface B1c of the rotor B1 (see FIG. 1).

Moreover, the symmetrical axis AX is arranged to pass through an axle CW and a central portion of the caliper B2 while, in a view in a vehicle width direction, overlapping a knuckle arm W1a which extends from a knuckle W1 in a way the knuckle arm W1a becomes lower toward the rear (see FIG. 2).

Specifically, the symmetrical axis AX is set inclined to a vehicle front-rear direction with a front-side portion of the symmetrical axis AX located higher than the axle CW, and with a rear-side portion of the symmetrical axis AX located lower than the axle CW.

Next, descriptions will be provided for each component of the disc brake B (see FIGS. 1 to 3).

The rotor B1, together with the rear wheel (the wheel), is pivotally supported by the knuckle W1 (the vehicle body) with the hub bearing W2 in between (see FIG. 3). Besides, the rotor B1 has a substantial disc shape which is circular around the axle CW of the rear wheel (the wheel), and is arranged to face the rotational surface of the rear wheel (the wheel) in parallel with each other.

It should be noted that in FIG. 3, the rotor B1 rotates in a counterclockwise direction relative to the splash guard 10 while the vehicle is running forward.

The rotor B1 includes a rotor supporting part B1a and a sliding part B1b.

The rotor supporting part B1a is a central portion of a substantially disc shape of the rotor B1.

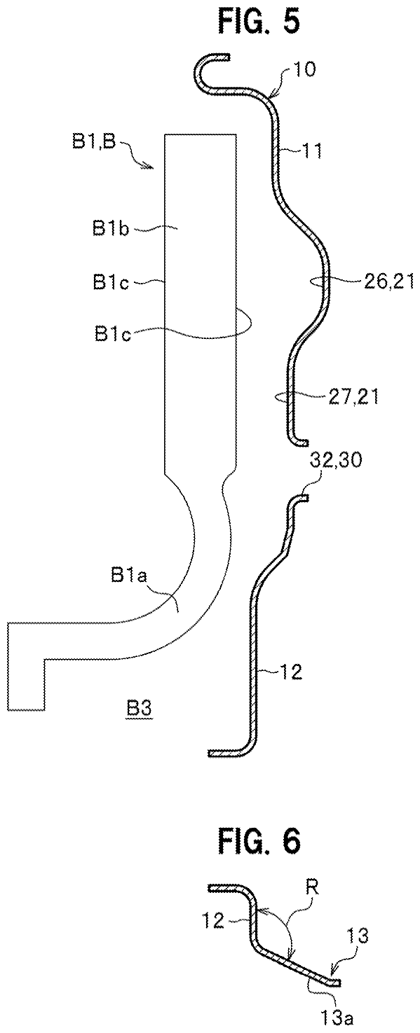

Furthermore, the rotor supporting part B1a has a cross section shaped substantially like the letter J, and supports the sliding part B1b with the sliding part B1b offset from an attachment surface B1d in the vehicle width direction (see FIG. 5).

The sliding part B1b has an annular shape, and is an outer circumferential portion of the substantial disc shape of the rotor B1.

In other words, the sliding part B1b is formed to integrally continue from a radially outer side of the rotor supporting part B1a with the center of the sliding part B1b and the center of the rotor supporting part B1a coinciding with each other at the axle CW.

The caliper B2 is arranged on a portion of the knuckle W1, which faces the rotor's outer peripheral edge, while located on an opposite side of the axle CW from the knuckle arm W1a extending from the knuckle W1 (see FIGS. 1 and 3).

Furthermore, the external shape of the caliper B2 is formed and arranged to be linearly symmetrical with respect to the symmetrical axis AX.

Moreover, the caliper B2 has a substantially angular U-shaped cross section, and is arranged on the knuckle W1 while fitting over the sliding part B1b with the sliding part B1b located inside an angular U-shaped inner recessed portion.

In other words, the caliper B2 is arranged over the sliding part B1b in a plate-thickness direction.

The caliper B2 includes the brake pads (not illustrated) placed therein in a way that enables the brake pads to project to the sliding part B1b.

When the driver steps on the brake pedal, the brake pads are squeezed against the sliding part B1b to generate friction between the brake pads and the sliding part B1b. The friction acts on the sliding part B1b as a braking force.

The splash guard 10 is arranged between the rotor B1 and the knuckle W1, and is fixed to the knuckle W1 while covering the rotor B1 from inside in the vehicle width direction (see FIGS. 1 to 3).

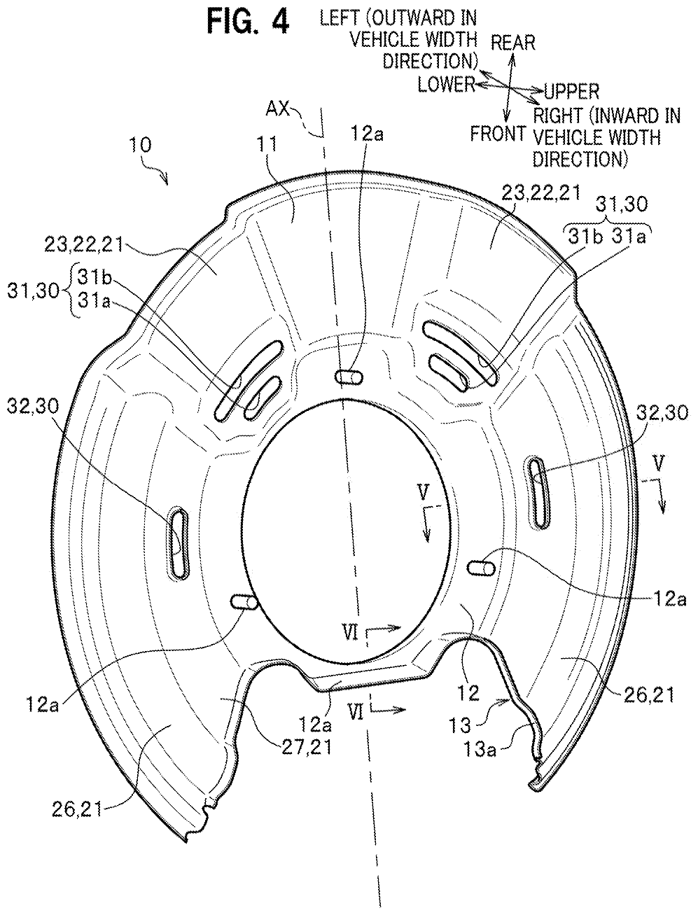

In addition, the splash guard 10 is formed to be substantially linearly symmetrical with respect to the symmetrical axis AX (see FIG. 4).

Thus, the splash guard 10 is usable in both the left and right sections of the vehicle by being turned around the symmetrical axis AX by 180 degrees, that is to say, by being turned inside out.

The splash guard 10 includes a guard main body 11, fixing parts 12, a notch part 13, cooling holes 30 and offset parts 21.

The guard main body 11 forms an external shape of the splash guard 10, and is made of a disc-shaped member whose shape corresponds to an external shape of the rotor B1.

The fixing parts 12 work to fix the splash guard 10 to the knuckle W1, and are set respectively in three portions of the splash guard 10 which face the rotor supporting part B1a of the rotor B1.

A first fixing part 12 is set on a portion of the symmetrical axis AX which is located further inward in a radial direction than the cooling holes 30 while facing the rotor supporting part B1a of the rotor B1.

The two other fixing parts 12 are set respectively in two portions of the splash guard 10 which are located at the same radius as the first fixing part 12, and at equal angular intervals (of 120 degrees) from the first fixing part 12.

The fixing parts 12 are each made from a hole which penetrates through the splash guard 10 in the plate thickness direction.

Bolts (not illustrated) penetrating through the fixing parts 12 are screwed to internally threaded portions (not illustrated) formed in the knuckle W1, and the splash guard 10 is thereby fixed to the knuckle W1.

A method of fixing the fixing parts 12 to the knuckle W1 may be employed depending on the necessity, as long as the method does not hinder the rotation of the rotor B1, the rotation of the wheel, or the action of the caliper B2.

In addition, each fixing part 12 faces the substantially J-shaped portion of the rotor supporting part B1a. Thus, a relatively large clearance B3 is formed between the fixing part 12 and the rotor supporting part B1a. This clearance B3 functions as a discharge route through which to discharge foreign objects (see FIG. 5).

The notch part 13 is formed in a portion of the guard main body 11 which faces the caliper B2 when the splash guard 10 is attached to the knuckle W1 (see FIGS. 4 and 5). The notch part 13 is formed corresponding to the external shape of the caliper B2.

In addition, the splash guard 10 is adjacently arranged to face and cover the corresponding sliding surface B1c of the sliding part B1b with the caliper B2 placed inside the notch part 13.

Furthermore, the notch part 13 includes an edge wall 13a formed along a notch edge and standing toward the knuckle W1 (see FIGS. 4 to 6).

The edge wall 13a is provided standing diagonal to the plate surface of the guard main body 11 such that an angle R of the edge wall 13a to the guard main body 11 is an obtuse angle. Incidentally, the angle R is set at 115 degrees.

Since the edge wall 13a is set like this, paint flows down along the edge wall 13a without staying along a corner at the angle R in a case where the paint is applied to the splash guard 10 and the resultant splash guard 10 is hung and dried.

This inhibits the paint from being accumulated along the corner at the angle R. Since the paint is inhibited from being accumulated there, risks of poor painting, insufficient drying and the like can be reduced.

The cooling holes 30 are made of six through-holes penetrating through the plate surface, and are divided into three sets of cooling holes 30, which are arranged at positions symmetrical to each other with respect to the symmetrical axis AX (see FIG. 1).

The cooling holes 30 included in the two sets among the three sets are classified into double holes 31. The cooling holes 30 included in the other set are classified into burring holes 32. Incidentally, detailed descriptions will be later provided for each classification.

In addition, each cooling hole 30 is open in a portion of the plate surface which faces the rotor supporting part B1a (see FIG. 3).

Specifically, each cooling hole 30 is open in a portion of the plate surface facing a portion of the rotor B1 which is closer to the axle CW (further inward in the radial direction) than the sliding surface B1c.

Every cooling hole 30 is made of a long hole shaped like an arc around the axle CW.

Furthermore, a radial-direction dimension of each cooling hole 30 is set narrower than the clearance between the sliding surface of the rotor B1 and the plate surface of the splash guard 10.

Thus, the particle size of foreign objects getting in from the cooling holes 30 is smaller than the clearance between the rotor B1 and the splash guard 10. This makes it possible to discharge incoming foreign objects quickly.

Moreover, among the cooling holes 30, those located above the axle CW are set at positions not overlapping the hub bearing W2 (behind the hub bearing W2) in a plan view.

In other words, the cooling holes 30 are open at positions which do not allow muddy water getting in through the cooling holes 30 to be splashed over the hub bearing W2 when the muddy water falls down.

It should be noted that no restriction is imposed on a positional relationship between cooling holes 30 not located above the axle CW and the hub bearing W2. In other words, the cooling holes 30 not located above the axle CW may be arranged at positions overlapping the hub bearing W2 in the plan view.

This is because muddy water getting in from the cooling holes 30 located below the axle CW does not fall down onto the hub bearing W2.

Next, descriptions will be provided for the double holes 31 and the burring holes 32 (see FIGS. 1 to 3).

Each double holes 31 are made of two cooling holes 30 continuing in the radial direction from the axle CW.

Incidentally, of the two cooling holes 30 continuing in the radial direction, one located inward in the radial direction will be referred to as an inner hole 31a while the other located outward in the radial direction will be referred to as an outer hole 31b.

The length of the arc and the radial-direction dimension of each of the double holes 31 are set such that an opening area of the outer hole 31b is greater than that of the inner hole 31a.

In a case where the rotating rotor B1 sends foreign objects flying after the foreign objects get in through the inner hole 31a, this configuration enables the foreign objects to be discharged through the outer hole 31b.

In addition, the configuration makes it possible to increase an overall opening area while reducing the opening area of each cooling hole 30.

This configuration makes it possible to obtain a sufficient cooling performance from the cooling holes 30 while inhibiting foreign objects from getting in through the cooling holes 30.

A burring process is applied to each burring hole 32 such that a hole edge of the burring hole 32 projects inward in the vehicle width direction (in a direction away from the rotor B1) (see FIGS. 4 and 5).

Thus, foreign objects are inhibited from getting in through the burring holes 32. In addition, the providing of the burring holes 32 makes it possible to slow a decrease in the strength of the splash guard 10.

Next, descriptions will be provided for the offset parts 21 (see FIGS. 1 to 3).

Each offset part 21 is a portion of the splash guard 10 which is offset in a direction in which a clearance between the splash guard 10 and the corresponding sliding surface B1c of the rotor B1 becomes wider.

Incidentally, the clearance formed between the offset part 21 and the rotor B1 will be referred to as an offset clearance 25.

The offset clearance 25 functions as a discharge route through which to discharge foreign objects when the foreign objects get between the splash guard 10 and the rotor B1.

The offset parts 21 in pairs are arranged in portions of the guard main body 11 which are linearly symmetrical with respect to the symmetrical axis AX. A position, a shape and an amount of offset are set for each offset part 21.

The offset parts 21 are classified into radial-direction offset parts 22 and circumferential-direction offset parts 26.

The radial-direction offset parts 22 are arranged respectively in portions of the guard main body 11 which are other than those overlapping the knuckle arm W1a, and are each formed substantially in the shape of a sector which extends outward in the radial direction from the axle CW (see FIGS. 1 to 3).

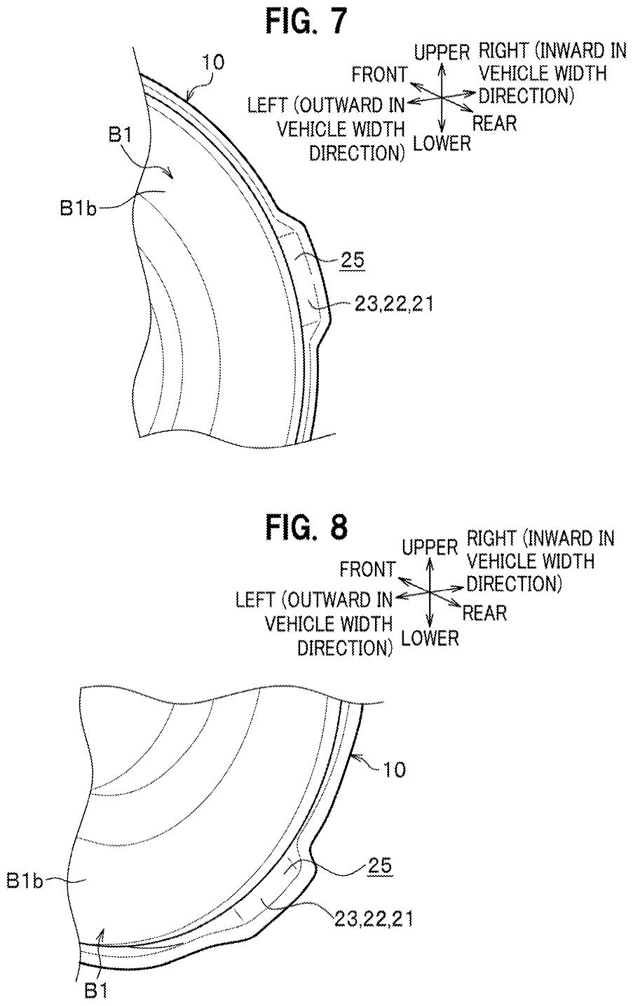

In addition, each radial-direction offset part 22 is formed of a recessed portion having a substantially trapezoidal cross section, and becoming gradually narrower as the plate surface 10a becomes farther from the sliding part B1b (see FIGS. 7 and 8).

The radial-direction offset parts 22 are classified into radially-outer offset parts 23 and radially-inner offset parts 24.

Each radially-inner offset part 24 is formed in a peripheral portion of the splash guard 10 which faces the rotor supporting part B1a including the double holes 31 (see FIG. 3).

Each radially-outer offset part 23 is formed continuing from a radially-outer side of the corresponding radially-inner offset parts 24, stretching along an inner to an outer peripheral edge of the sliding part B1b, and facing the sliding surface B1c of the rotor B1.

Furthermore, each radially-outer offset part 23 is set such that an amount of offset in the radially-outer offset part 23 is greater than an amount of offset in the corresponding radially-inner offset part 24.

In other words, each radial-direction offset part 22 is set such that an amount of offset in the radial-direction offset part 22 becomes gradually larger toward the radially-outer side from the radially-inner side.

In addition, each radial-direction offset part 22 is set further outward in the radial direction than the corresponding cooling holes 30.

Thus, when foreign objects get in through the cooling holes 30, the foreign objects are quickly discharged to the outside via the radially-outer offset parts 23.

The circumferential-direction offset parts 26 are each made of a groove-shaped recessed portion having a substantially trapezoidal cross section (see FIGS. 1 to 5).

The circumferential-direction offset parts 26 are formed extending from the notch part 13 to the respective radially-outer offset parts 23, and shaped like an arc around the axle CW which curves in the circumferential direction.

Each circumferential-direction offset part 26 is set such that an amount of offset in the circumferential-direction offset part 26 is less than the amount of offset in each radially-outer offset part 23.

Thus, when foreign objects get into the radial-direction offset parts 26, the foreign objects are quickly discharged through the radially-outer offset parts 23.

It should be noted that the notch part 13 and the radially-outer offset parts 23 which continue to each other via the circumferential-direction offset parts 26 are arranged such that the notch part 13 is located above the radially-outer offset parts 23.

When foreign objects get in through the notch part 13, this arrangement mode quickly discharges the foreign objects through the radially-outer offset parts 23 after moving the foreign objects along the circumferential-direction offset parts 26.

Next, descriptions will be provided how the disc brake B (the vehicle braking system) according to the embodiment works and what effects the disc brake B brings about.

The splash guard 10 is set in the disc brake B according to the embodiment for the main purpose of protecting the rotor B1, the brake pads and the caliper B2.

In addition, the splash guard 10 according to the embodiment includes the multiple cooling holes 30, and is formed in the shape linearly symmetrical with respect to the symmetrical axis AX that is the straight line intersecting the axle CW and extending on the plate surface 10a.

This configuration makes it possible to use the splash guard for the right rear wheel disc brake as the splash guard for the left rear wheel disc brake when the splash guard for the right rear wheel disc brake is turned (reversed) around the symmetrical axis AX by 180 degrees.

In other words, the splash guard 10 in the single shape is applicable to both the left and right disc brakes B.

This makes it possible to achieve the commonality of the parts in both the left and right sections of the vehicle, and to reduce manufacturing costs.

Furthermore, in the embodiment, the symmetrical axis AX is the straight line set to extend along the sliding surface B1c of the rotor B1, and to overlap the knuckle arm W1a in the vehicle width direction.

Furthermore, the symmetrical axis AX is set to pass through the central portion of the caliper B2 and the axle CW.

These make it no longer necessary to form a more-than-necessary number of offset parts 21 in the splash guard 10, and make it possible to achieve the commonality of the left and right parts while allowing the splash guard 10 to maintain the function of inhibiting foreign objects from getting in.

As the cooling holes 30, the double holes 31 made of the pairs of inner and outer holes 31a, 31b open continuously in the radial direction are included in the splash guard 10 according to the embodiment. The opening area of each outer hole 31b is set greater than that of each inner hole 31a.

For example, the outer holes 31b and the inner holes 31a are each made of a long hole shaped like an arc around the axle CW, and are set such that the radial-direction dimension of the outer holes 31b and that of the inner holes 31a are equal to each other.

When foreign objects get in through the inner holes 31a (the cooling holes located inward in the radial direction), this configuration quickly discharges the foreign objects through the outer holes 31b (the holes located outward in the radial direction) by doing things such as causing the rotating rotor B1 to send the foreign object flying outward in the radial direction.

In addition, this configuration secures the overall opening area large enough for the cooling while reducing the opening area of each cooling hole 30.

This makes it possible to prevent foreign objects each with a large particle diameter from getting in though the cooling holes 30, and to obtain the sufficient cooling performance while preventing the foreign objects from being caught between the splash guard 10 and the rotor B1.

Furthermore, since the particle diameter of incoming foreign object is smaller than otherwise, the foreign objects can be quickly discharged through portions other than the outer holes 31b.

In the splash guard 10 according to the embodiment, each cooling hole 30 is open in a portion of the plate surface which faces the rotor supporting part B1a which is located closer to the axle CW (further inward in the radial direction) than the sliding surface B1c of the rotor B1.

In a case where muddy water gets in through the cooling holes 30, the employment of the above configuration can reduce an amount of muddy water to be splashed over the sliding surfaces B1c of the rotor B1.

This makes it possible to inhibit a decrease in the braking force while rain is falling, and to inhibit rusting of the sliding surfaces B1c.

The splash guard 10 according to the embodiment includes the radial-direction offset parts 22 each having a recessed shape, and obtained by offsetting the plate surface 10a in the direction in which the clearance between the plate surface 10a and the corresponding sliding surface B1c and the rotor B1 becomes wider.

Moreover, each radial-direction offset parts 22 is recessed in the radial direction, and extends along the radially inner to outer peripheral edges of the corresponding sliding surface B1c of the rotor B1.

When foreign objects get between the rotor B1 and the splash guard 10, the employment of this configuration enables the foreign objects to be quickly discharged through the radial-direction offset parts 22.

The splash guard 10 according to the embodiment includes the notch part 13 cut along the external shape of the caliper B2 which is arranged to straddle the sliding part B1b of the rotor B1 in the plate thickness direction.

The splash guard 10 further includes the groove-shaped circumferential-direction offset parts 26 extending from the notch part 13 to the respective radially-outer offset parts 22, and each obtained by offsetting the plate surface 10a in the direction in which the clearance between the plate surface 10a and the corresponding sliding surface B1c becomes wider.

When foreign objects get between the splash guard 10 and the rotor B1, the employment of this configuration makes it possible to quickly discharge the foreign objects through the radial-direction offset parts 22 by moving the foreign objects along the circumferential-direction offset parts 26.

In the splash guard 10 according to the embodiment, the amount of offset in each circumferential-direction offset part 26 is set greater than the dimension (gap) between the caliper B2 and the notch part 13.

In addition to this, the amount of offset in each circumferential-direction offset part 26 is set less than the amount of offset in each radial-direction offset part 22.

When foreign objects get between the splash guard 10 and the rotor B1, the employment of this configuration makes it possible to quickly discharge the foreign objects without allowing the foreign objects to be caught in the clearance in the middle of the discharging process.

It should be noted that in the embodiment, the hole diameter of each cooling hole 30 is set less than the dimension between the splash guard 10 and the rotor B1.

When foreign objects get into the clearance through the cooling holes 30, this configuration quickly discharges the foreign objects without allowing the foreign objects to be caught or jammed between the splash guard 10 and the rotor B1.

In addition, the shape of each cooling hole 30 is not limited to the arc-shaped long hole.

For example, the cooling hole 30 is made of circular holes arranged continuously in the circumferential direct and into the shape of an arc. This configuration brings about the same effect.

Moreover, although in each circumferential-direction offset part 26 according to the embodiment, the amount of offset in any portion from the notch part 13 to the corresponding radially-outer offset part 23 is set equal to the amount of offset in the other portions, the amount of offset is not limited to this mode.

For example, the amount of offset may be made to become gradually greater toward the corresponding radial-direction offset part 22 from the notch part 13.

The employment of this mode makes it possible to inhibit more of foreign objects from being caught in the circumferential-direction offset parts 26, and to discharge the foreign objects more quickly.

What is claimed is:

1. A vehicle braking system comprising a splash guard
adjacently arranged on a knuckle while facing a sliding part of a disc-shaped rotor that rotates about an axle,
made of a plate-shaped member which includes a plurality of cooling holes each being a through-hole penetrating through a plate surface, and
formed in a shape linearly symmetrical with respect to a symmetrical axis that is a straight line located on the plate surface and intersecting the axle.

2. The vehicle braking system according to claim 1, wherein
the symmetrical axis is set
to, in a vehicle width direction, overlap a knuckle arm extending from the knuckle, and
to pass through the axle and a central portion of a caliper arranged to straddle the sliding part of the rotor in a plate thickness direction.

3. The vehicle braking system according to claim 1, wherein
the plurality of cooling holes are set such that an opening area of the cooling hole located outward in a radial direction from the axle is greater than that of the cooling hole located inward in the radial direction.

4. The vehicle braking system according to claim 1,
wherein each cooling hole is open in a portion of the splash guard which faces a portion of the rotor located further inward in the radial direction than the sliding part.

5. The vehicle braking system according to claim 2, wherein
the splash guard includes a radial-direction offset part formed in such a way that a portion of the plate surface facing the sliding part of the rotor and extending from a radially-inner peripheral edge to a radially-outer peripheral edge of the splash guard is offset in a direction in which a clearance between the plate surface and the sliding part becomes wider.

6. The vehicle braking system according to claim 5, wherein
the splash guard includes
a notch part cut along an external shape of the caliper, and
a groove-shaped circumferential-direction offset part extending from the notch part to the radial-direction offset part, and formed by offsetting the plate surface in the direction in which the clearance between the plate surface and the sliding part becomes wider.

7. The vehicle braking system according to claim 6, wherein
an amount of offset in the circumferential-direction offset part is set greater than a dimension between the caliper and the notch part, and less than an amount of offset in the radial-direction offset part.
